(19) United States
(12) Patent Application Publication
(10) Pub. No.: US 2009/0055090 A1
(43) Pub. Date: Feb. 26, 2009

(54) METHODS AND SYSTEMS FOR LOCATING POSITIONS

(76) Inventors: Timothy Cowley, Foxborough, MA (US); Carolyn Chlebek, Foxborough, MA (US); Georgia Duncan, Foxborough, MA (US); Jeremy Gygi, Foxborough, MA (US); Alan Scharman, North Attleborough, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/841,304

(22) Filed: Aug. 20, 2007

(51) Int. Cl. G01C 21/00; G06F 17/30; G06F 17/40

(52) U.S. Cl. 701/207

(57) ABSTRACT

The methods and systems provide computer-generated software downloadable into cellular phone devices or other devices. The software programs the cellular device to mark and then locate a location based on its longitudinal and latitudinal position and elevation. The software utilizes all of the cellular device's capabilities to precisely identify locations using, but not limited to, GPS global positioning systems and Wi-Fi wireless fidelity data and information. The software informs the user of the marked location by displaying the position and pointing the user back to the marked location, in three dimensions, as needed, for example, to find the user's vehicle parked in a parking garage.

### BACKGROUND OF THE INVENTION

1. Field

The disclosed invention relates to a method and system that enables the user of a hand-held device to mark and then locate a position based on its coordinates. A visual or audible display, or a combination thereof, on the hand-held device provides three-directional information to lead the user back to the marked position.

2. Description of Art

It is common for persons to park their vehicles in large parking lots or parking garages, and then try to return to the vehicle after shopping or working or dining out or doing anything, only to discover that they can not find the location of their vehicle. Since persons will often get out of their vehicle and try to find a marker like a utility pole to help them remember the location of the vehicle. Some parking lots or garages have labeled locations to assist persons in knowing where to find their vehicles when they return. However, in all cases a person is required to remember or write down the marker or designation of the location. In many cases, persons find it a nuisance to locate their vehicle, often spending much time searching the parking lot or garage. In rare cases, a person may lose their vehicle for very long periods of time and may have other problems arise due to their search for their vehicle, like getting hit by a moving car.

In other instances, two or more people may wish to rendezvous at a specific location after spending some time shopping or sightseeing on their own. Additionally, a person may want to find his or her way back to a specific seat or area in a large auditorium or theatre.

There are many vehicle location devices designed to assist people in finding their vehicles or recalling where their vehicles are located. Before the age of commercially available wireless technology, conventional devices for locating parked vehicles used visual markers such as flags, banners, pennants or streamers, which are supported from an antenna, or masts with magnetic bases for attaching to vehicle roofs.

More recent devices use electronic wireless techniques to locate vehicles. For example, a mobile vehicle location system can include a location determination system, such as the Global Positioning System (“GPS”), in combination with a transceiver or transmitter and a receiver. In other systems, the vehicle location system may be placed in the target vehicle. While the vehicle location may be determined by remotely communicating with the location system, the user's location cannot be known with the same device when the user is outside the vehicle. Therefore, such systems are unable to determine the relative position of the vehicle to the user.

Certain automobile manufacturers have proposed systems having a GPS receiver wired to a vehicle's key. The system records the vehicle's GPS position every time the key is removed from the vehicle's ignition. If the user requests directions to its parked vehicle, the system determines the current GPS position and the current heading. It then calculates and displays a pointer to the parked vehicle location. This system requires a specially designed key and does not function reliably in indoor parking lots. Additionally, the system can only record the location of the vehicle and not other locations. For all the devices and methods described in the literature, the usage is found to be limited to locating a vehicle.

Other navigation devices cooperate with location systems such as GPS, Global Navigation System (“GLONASS”), Global Navigation Satellite System (“GNSS”) or Long Range Navigation (“LORAN”) to provide a user with the latitude and longitude of a location. These devices could be used to direct a user back to a desired location, like the location of a parked vehicle. For instance, if the latitude and longitude of a parked vehicle were entered into the navigation device, the device could readily calculate the distance and location relative to the vehicle. A disadvantage with using such a device for locating a parked vehicle is that the user must know or be able to determine the coordinates of a vehicle and must enter these coordinates into the navigation device every time the location of the vehicle changes.

### SUMMARY

The disclosed methods and systems utilize hand held devices, such as mobile cellular phones, personal digital assistants (PDAs), digital music, video or game players, or other devices to pre-mark one or more vehicle or other locations, and then direct the user back to the one or more locations. They may also provide the user with the relative elevation between the user's current location and the marked location. Such elevational information may be particularly useful, for example, in locating a vehicle in a multi-level parking facility.

When activated by a user, the device may “grab” the GPS or Wi-Fi or other positioning information to mark the critical original location, for example the location of a parked vehicle in a large parking lot or garage. When prompted by a user, the device may then calculate distance, relative location directions for returning to the marked position from its current location and may then direct the user to the marked position. The device may include a user interface, such as a screen display, for providing the directions to the user. For example, a pointer may be displayed that points to the marked location in a manner similar to a compass bearing. In addition the display may include distance and elevational information to indicate the distance to the marked location and also whether the user needs to move up or down in elevation to return to the marked location. The interface may include audio information in addition to or in lieu of a visual display.

In one embodiment, a method for locating a position comprises receiving a signal from a user of a device to mark the position, determining coordinates for the position based on a location of the device at the time the signal to mark the position is received, storing the coordinates in a memory of the device, receiving a signal from a user of the device to locate the position, determining directional information based on differences between stored coordinates for the position and coordinates of a location of the device at the time the signal to locate the position is received, and providing the directional information to the user.

In one embodiment, the method may include receiving a signal from the user identifying the position to be marked. In other embodiments, the method may include periodically updating the directional information or providing a signal to the user when the device approaches within a predetermined distance of the position.

In some embodiments, the method may include receiving a signal from the user to mark at least one additional position and storing identifying information for each position marked. Receiving a signal from a user of the device to locate the position may include receiving a signal from the user selecting one of the positions based on the identifying information for the one position. Storing identifying information for each position marked may include storing a sequence identifier for at least two of the positions. Providing the directional information to the user may include determining directional information for a next position in the sequence based on differences between stored coordinates for the next position and coordinates of a location of the device when the device approaches within a predetermined distance of the position and providing the directional information for the next position to the user.

In some embodiments, receiving a signal from the user to mark at least one additional position may include obtaining a current location of the device, storing coordinates for the current location when a coordinate difference between the current location of the device and a previously stored position is greater than a predetermined distance, storing a sequential identifier for the stored current location and periodically returning to obtain the current location.

In some embodiments providing the directional information to the user may include determining a next previously stored position based on the sequential identifier, determining directional information for the next previously stored position in the sequence based on differences between stored coordinates for the next previously stored position and coordinates of a current location the device, providing the directional information for the next previously stored position to the user and returning to determining a next previously stored position when the device approaches within a predetermined distance of the next previously stored position.

In some embodiments, the method may include instructions on computer-readable medium for controlling a processor of the device wherein the device is a hand held device. The instructions may control the processor of a cellular phone, a personal digital assistant, a digital music player, a digital video player or a game player. In some embodiments, the method may include receiving seating information for the position, wherein the coordinates are further based on the seating information and the directional information conforms to a seating layout of which the position is one seat.

In another embodiment, a computer-readable medium contains instructions for controlling a processor of a hand held device to receive a signal from a user of the hand held device to mark the position, determine coordinates for the position based on a location of the hand held device at the time the signal to mark the position is received, store the coordinates in a memory of the hand held device, receive a signal from a user of the hand held device to locate the position, determine directional information based on differences between stored coordinates for the position and coordinates of a location of the hand held device at the time the signal to locate the position is received, and provide the directional information to the user.

In another embodiment, a hand held device enables a user to locate a position. The hand held device includes a user interface for enabling the user to submit commands to mark the position and locate the position, a processor for storing coordinate information for the marked position and determining directional information based on coordinate differences between the coordinate information for the marked position and coordinate information for a current position of the hand held device and a display for presenting the directional information to the user.

### BRIEF DESCRIPTION OF THE DRAWINGS

FIG. 1 is an illustrative flow diagram of a method of locating a position;

FIG. 2 is an illustrative screen display for marking a position; and

FIG. 3 is an illustrative screen display for locating a position.

### DESCRIPTION OF CERTAIN EMBODIMENT(S)

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the spirit and scope of the systems and methods described herein.

Unless otherwise specified, the illustrated embodiments should be understood as providing exemplary features of varying detail of certain embodiments, and therefore, unless otherwise specified, features, components, modules, or aspects of the illustrations can be otherwise combined, separated, interchanged, or rearranged without departing from the disclosed systems or methods. Additionally, the shapes and sizes of components are also exemplary and unless otherwise specified, can be altered without departing from the disclosed systems or methods.

The methods and systems set forth herein may include instructions on computer-readable medium. The methods and systems are particularly advantageous when used with hand held devices such as cellular phones, personal digital assistants, or other such known devices. For ease of illustration, but not limitation, the descriptions and figures herein refer to hand held devices, though the methods and systems may also find use on other, less portable devices, such as laptop or tablet computers. The instructions control the hand held device such that a user can mark a position based on the device storing the position's coordinates. The device may obtain the position's coordinates utilizing known positioning technologies currently available for hand held devices. For example, but without limitation, the hand held device may incorporate Global Positioning System (GPS) technology, or Wi-Fi wireless fidelity data and information, or a combination thereof Those of skill in the art will recognize that the methods and systems described herein are operable with many types of positioning or coordinate systems. Once a position has been marked, the user can access an interface on the device that can direct the user to the marked position. For example, the instructions can control the device to calculate a bearing from the user's current location to the marked location and to display a pointer on the hand held device depicting the bearing. Elevational information, such as the relative elevation between the current locations and the marked location, may also be displayed. In some instances, such as locating a position in a multilevel parking garage, such elevational information may indicate that the user needs to move to a different level to return to the marked location.

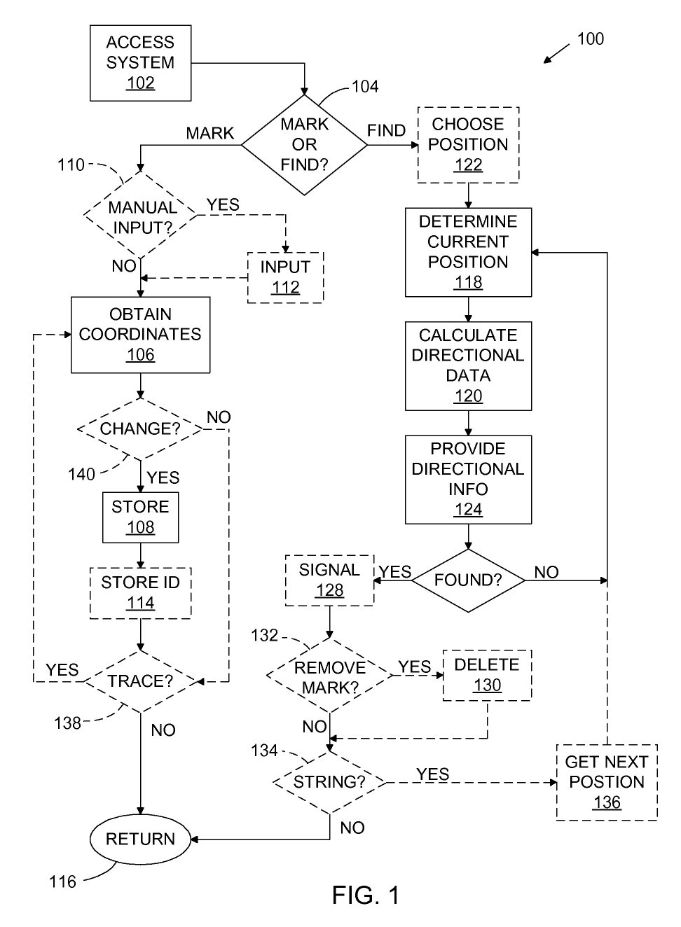

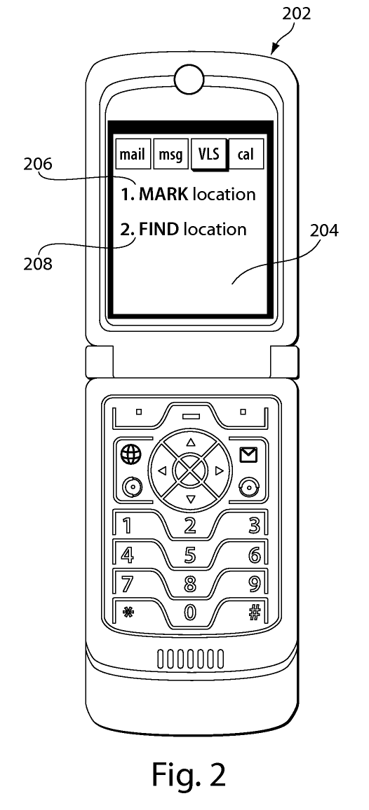

Referring to FIG. 1, there is illustrated a flow diagram 100 for an exemplary embodiment of a method for locating a position. Referring also to FIG. 2, there is illustrated an exemplary embodiment of a user interface for use with the methods and systems described herein. On a hand held device, such as device 202 a user may first access the system, as at block 102. Depending on the specific interface and device, the user may access the system by choosing an icon from a menu, by one or more keystroke entries, or by other means as are known in the art, including, without limitation, voice commands, touch sensitive screens, or combinations of such means. In some embodiments, the device may be dedicated to the methods and systems described herein, such that access may be obtained by turning on the device. For the exemplary embodiment of FIG. 2, wherein the hand held device is a cellular phone 202, the user may access the system from a menu listing.

Upon accessing the system, the user may choose to mark a position or find a position, as at decision block 104 of FIG. 1. FIG. 2 illustrates screen 204 having menu items MARK (206) and FIND (208) shown thereon. Those of skill in the art will recognize that the placement, size, style and other aspects of the items on the exemplary screens are for illustration purposes only and not for limitation. Upon choosing to MARK a position, the device obtains (block 106) and stores (block 108) the coordinates for the current position of the device. The coordinates may be obtained utilizing one or more positioning technologies that may be available for use with hand held devices, including, without limitation, GPS technology. Optionally upon choosing to MARK a position, as indicated by dashed lines in FIG. 1, a user may be given a choice (block 110) to manually input the position to be marked (block 112). The manual input may include coordinate information, a known address, or other identifying information recognized by the system. For example, the device may be programmed to recognize seat and row information for a stadium, or a spot may be chosen from a map displayed on the screen.

The system may include the ability to store a number of positions. Accordingly and optionally, the user may be given the opportunity to provide identifying information that may also be stored for the position, as at block 114. For example, a user may agree to meet one friend at one position and another friend at another position. The stored input for each position may include a user input identifier for the position that indicates which friend the user is to meet at that position. In some embodiments, storing the coordinate or identifying information, or both, may include uploading the information to a central database. Upon storing the coordinate information and optional identifier information, the user may return to a main screen for the device, as at block 116.

Upon choosing to FIND a position at decision block 104, the system obtains coordinate information for the current position of the hand held device (block 118), in a manner similar to marking positions, by using the one or more available positioning technologies. The system then determines (block 120) a bearing, distance and elevation difference from the current position of the hand held device to the marked position stored in the device, as at block 120. Optionally, where more than one position may have been stored, the user may choose one position from among the stored positions, as illustrated at block 122. For example, but without limitation, the user may choose the position from a textual or audible listing of the identifiers for the positions, or the user may choose the position from a map indicating the location and identifier for each of the marked positions. Other user interfaces for providing the user a listing of stored positions from which to choose may be contemplated. Where the coordinate or identifying information for the marked position was uploaded to a central database, determining the bearing, distance and elevation difference may include downloading the information from the central database. Preferably, the determining is performed locally. However, the determining may be performed at a central processor if the coordinate information for the marked position and the current position are uploaded to the central processor, with the results downloaded to the hand held device.

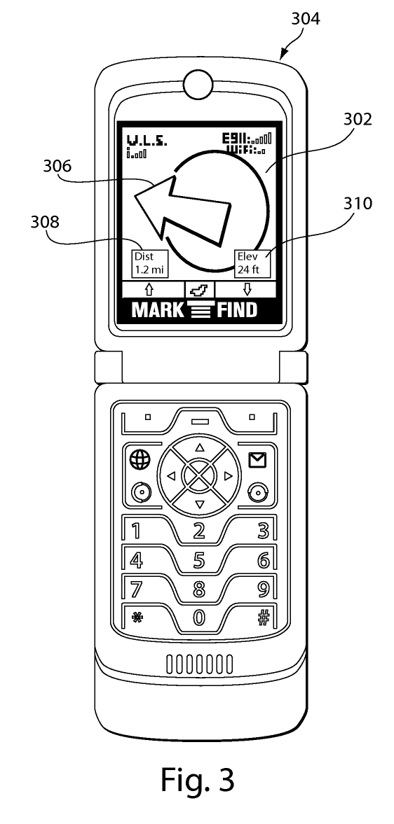

Upon determining the bearing, distance and difference in elevation, the system provides directional information to the user, as at block 124. For the exemplary embodiment of FIG. 3, screen 302 of device 304 may display a directional arrow 306 corresponding to the determined bearing. Additionally or optionally, the distance (308), the elevation difference (310), or both may be displayed, as well as the coordinates of either or both of the current position and the stored position. Those of skill in the art may contemplate additional forms of directional information, including, without limitation, audible signals or directions, position and direction indicating maps, such as those used in known navigation systems, compass headings, or combinations of these and other forms of directional information.

The system continues to periodically update the directional information by returning to block 118 until the device is within a predetermined distance of the stored position, as illustrated by block 126. The predetermined distance can be a system default, for example ten feet, or optionally, some arbitrary distance chosen by the user. (The user may choose to terminate the FIND operation at any time.) Optionally, the system may provide a visual, audible, or tactile signal, or a combination thereof, to the user to indicate that the user has arrived at the stored position (block 128). Once the device is at or near the position, the stored position can be removed from storage (block 130). For the exemplary embodiment of FIG. 1, the user may be given the option to remove or keep the location in storage, as at decision block 132. As with the MARK operation, the user may return to a main screen for the device (block 116) upon completion of the FIND operation.

In one embodiment, the system may store multiple positions as the user moves away from a marked position. For example, the system may store a new position when the user moves more than a predetermined distance away from the last stored position. Each new position may include an incremental identifier provided by the system. In this manner, the unit may trace a path that the user takes from the marked position. Such tracing may be helpful to a user when solely directional information may be inadequate. For example, a hiker who has wandered from a trail may want to trace his route back to a starting point. In such instances, directional information alone, even if accurate, may lead the hiker to locations that may not allow further travel.

FIG. 1 illustrates the optional tracing embodiment. If the system determines, as at decision block 138, that the user has chosen to trace the route from the marked position, the method returns to obtain the coordinates of the current position of the device (block 106). If the coordinate difference between the current position and the previously stored position is greater than the predetermined distance, as determined at block 140, the current position and its appropriate sequential identifier is stored (blocks 108, 114). As long as the system remains in the trace mode (as determined at block 138), the method periodically returns to obtain the coordinates for the current position of the device. The trace mode may be ended, e.g., by the user the user choosing either the MARK or FIND modes, or by another indication by the user, such as an END command. In retracing the path, the method operates in the manner described for multiple stored positions.

As used herein, a “user interface” is an interface between a human user and a computer that enables communication between the user and the computer. A user interface may include an auditory indicator such as a speaker, or a graphical user interface (GUI) including one or more displays, or a combination thereof A user interface also may include one or more selection devices including a mouse, a keyboard, a keypad, a track ball, a microphone, a touch screen, a game controller (e.g., a joystick), etc., or any combinations thereof

The various methods, acts thereof, and various embodiments and variations of these methods and acts, individually or in combination, may be defined by computer-readable signals tangibly embodied on one or more computer-readable media, for example, non-volatile recording media, integrated circuit memory elements, or a combination thereof Such signals may define instructions, for example, as part of one or more programs, that, as a result of being executed by a computer, instruct the computer to perform one or more of the methods or acts described herein, or various embodiments, variations and combination thereof Such instructions may be written in any of a plurality of programming languages or using any of a plurality of programming techniques.

For example, various methods according to the present disclosure may be programmed using an object-oriented programming language. Alternatively, one or more of functional, scripting, or logical programming languages may be used. Various aspects of the disclosure may be implemented in a non-programmed environment (e.g., documents created in HTML, XML or other format that, when viewed in a window of a browser program, render aspects of a graphical-user interface (GUI) or perform other functions). Various aspects of the disclosure may be implemented as programmed or non-programmed elements, or combinations thereof

A given computer-readable medium may be transportable such that the instructions stored thereon can be loaded onto any computer system resource to implement various aspects of the present disclosure. In addition, it should be appreciated that the instructions stored on the computer-readable medium are not limited to instructions embodied as part of an application program running on a host computer. Rather, the instructions may be embodied as any type of computer code (e.g., software or microcode) that can be employed to program a processor to implement various aspects of the present disclosure.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

The methods and systems described herein are not limited to a particular hardware or software configuration, and may find applicability in many computing or processing environments. For example, the algorithms described herein can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory or storage elements), one or more input devices, or one or more output devices. The processor thus can access one or more input devices to obtain input data, and can access one or more output devices to communicate output data. The input or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) is preferably implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), or can include an intranet or the internet or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), hand held device such as cellular telephone, digital music, video or game players, laptop, tablet hand held, or another device capable of being integrated with a processor(s) that can operate as provided herein. Accordingly, the devices provided herein are not exhaustive and are provided for illustration and not limitation.

References to “a processor” or “the processor” can be understood to include one or more processors that can communicate in a stand-alone or a distributed environment(s), and can thus can be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets or the Internet.

Many additional changes in the details, materials, and arrangement of parts, herein described and illustrated, can be made by those skilled in the art. Those of skill in the art may contemplate further enhancements of the methods and systems described herein. For example, the device may provide an indication of signal strengths for the available positioning technologies, such that the user may choose a preferred signal, or the device may automatically choose the strongest signal. The methods and systems may be configured to operate in one of a number of languages chosen by the user. In storing multiple positions, the positions may be strung together such that a user may be directed from one position in the string to a next position in the string without having to choose the next position to find. For example, optional decision box 134 of FIG. 1 may determine if the position is part of a string and, if so, proceed to the next position in the string (block 136).

What is claimed is:

1. A method for locating a position, comprising:
receiving a signal from a user of a device to mark the position;
determining coordinates for the position based on a location of the device at the time the signal to mark the position is received;
storing the coordinates in a memory of the device;
receiving a signal from a user of the device to locate the position;
determining directional information based on differences between stored coordinates for the position and coordinates of a location of the device at the time the signal to locate the position is received; and
providing the directional information to the user.

2. The method of claim 1, further comprising receiving a signal from the user identifying the position to be marked.

3. The method of claim 1, comprising periodically updating the directional information.

4. The method of claim 1, comprising providing a signal to the user when the device approaches within a predetermined distance of the position.

5. The method of claim 1, further comprising:
receiving a signal from the user to mark at least one additional position;
storing identifying information for each position marked.

6. The method of claim 5, wherein receiving a signal from a user of the device to locate the position comprises receiving a signal from the user selecting one of the positions based on the identifying information for the one position.

7. The method of claim 5, wherein storing identifying information for each position marked comprises storing a sequence identifier for at least two of the positions.

8. The method of claim 7, wherein providing the directional information to the user comprises:
determining directional information for a next position in the sequence based on differences between stored coordinates for the next position and coordinates of a location of the device when the device approaches within a predetermined distance of the position; and
providing the directional information for the next position to the user.

9. The method of claim 1, wherein the method comprises instructions on computer-readable medium for controlling a processor of the device wherein the device is a hand held device.

10. The method of claim 9, wherein the instructions control the processor of one of a cellular phone, a personal digital assistant, a digital music player, a digital video player and a game player.

11. The method of claim 5, wherein receiving a signal from the user to mark at least one additional position comprises:
obtaining a current location of the device;
storing coordinates for the current location when a coordinate difference between the current location of the device and a previously stored position is greater than a predetermined distance;
storing a sequential identifier for the stored current location; and
periodically returning to obtaining the current location.

12. The method of claim 11, wherein providing the directional information to the user comprises:
determining a next previously stored position based on the sequential identifier;
determining directional information for the next previously stored position in the sequence based on differences between stored coordinates for the next previously stored position and coordinates of a current location the device;
providing the directional information for the next previously stored position to the user; and
returning to determining a next previously stored position when the device approaches within a predetermined distance of the next previously stored position.

13. The method of claim 1, further comprising receiving seating information for the position, wherein:
the coordinates are further based on the seating information; and
the directional information conforms to a seating layout of which the position is one seat.

14. A computer-readable medium containing instructions for controlling a processor of a hand held device to:
receive a signal from a user of the hand held device to mark the position;
determine coordinates for the position based on a location of the hand held device at the time the signal to mark the position is received;
store the coordinates in a memory of the hand held device;
receive signal from a user of the hand held device to locate the position;
determine directional information based on differences between stored coordinates for the position and coordinates of a location of the hand held device at the time the signal to locate the position is received; and
provide the directional information to the user.

15. A hand held device enabling a user to locate a position, comprising:
a user interface for enabling the user submit commands to mark the position and locate the position;
a processor for storing coordinate information for the marked position and determining directional information based on coordinate differences between the coordinate information for the marked position and coordinate information for a current position of the hand held device; and
a display for presenting the directional information to the user.
